(19) United States
(12) Patent Application Publication
(10) Pub. No.: US 2004/0154455 A1
(43) Pub. Date: Aug. 12, 2004

(54) Insulation cutoff apparatus

(75) Inventors: Randy Runyan, Oxford, IA (US); Timothy A. Coon, Lisbon, IA (US)

Correspondence Address: Nicholas J. Tuccillo, Esq., McCormick, Paulding & Huber LLP, City Place II, 185 Asylum Street, Hartford, CT, 06103-3402, US

(73) Assignee: MET-COIL SYSTEMS CORPORATION, Westfield, MA (US)

(21) Appl. No.: 10/764,022

(22) Filed: Jan. 23, 2004

Related U.S. Application Data
(60) Provisional application No. 60/442,617, filed on Jan. 24, 2003.

(51) Int. Cl. B26D 3/00; B26D 5/08

(52) U.S. Cl. 83/875; 83/881; 83/56; 83/614

(57) ABSTRACT

A cutoff apparatus includes a blade and an actuator, the actuator being operatively connected to the blade for selectively moving the blade in a rectilinear direction. A cutting block is disposed adjacent the blade, and the cutting block is positioned off-center with respect to a plane defined by the blade's rectilinear movement. A depth control mechanism is utilized for selectively controlling a degree of movement of the blade toward the cutting block. Operation of the actuator selectively causes the blade to move in the rectilinear direction thereby impacting the cutting block to an extent in accordance with the depth control mechanism.

### CROSS REFERENCE TO RELATED APPLICATIONS

This application is entitled to the benefit of and incorporates by reference in its entirety essential subject matter disclosed in U.S. Provisional Application No. 60/442,617, filed Jan. 24, 2003.

### FIELD OF THE INVENTION

This invention relates in general to an insulation cutoff apparatus, and deals more particularly with an insulation cutoff apparatus having increased performance characteristics.

### BACKGROUND OF THE INVENTION

Ducts are extensively utilized in heating and ventilating systems to distribute heated or cooled air throughout a building structure. These ducts are commonly formed from differing gauges of sheet metal, or the like, in sections of predetermined lengths which are then connected to one another to form a continuous duct system for distributing air.

It is oftentimes necessary to integrate insulation material with ductwork in order to provide the required thermal characteristics for a given application. Typically, the insulation that is utilized is comprised of a fiberglass material and is commonly packaged as a continuous roll of insulation. Known cutting devices are then employed to unroll a predetermined amount of insulation and effect a severing action in accordance with the specific type, size and shape of ductwork that is intended to be insulated.

A new generation of insulating materials are now being developed apart from the known fiberglass-based insulations. The new insulating materials are designed to be more environmentally friendly and may be comprised of a cotton-based web, or the like. As compared to the known fiberglass-based insulations, the new generation of insulating materials are oftentimes more difficult to cut and, therefore, the known cutting devices—typically employed for fiberglass-based insulations—experience a certain amount of operational difficulties during the cutting process when utilized in conjunction with the new generation of insulating materials. It will be readily appreciated that the operational difficulties in obtaining clean, repetitive cuts of the new insulating materials results in reduced productivity and increased labor costs.

With the forgoing problems and concerns in mind, it is the general object of the present invention to provide an insulation cutoff device which overcomes the above-described drawbacks.

### SUMMARY OF THE INVENTION

It is an object of the present invention to provide an insulation cutoff apparatus.

It is another object of the present invention to provide an insulation cutoff apparatus which is capable of repetitively and effectively cutting sections from a roll of insulating material.

It is another object of the present invention to provide an insulation cutoff apparatus which is capable of repetitively and effectively cutting insulating materials being more dense than traditional fiberglass-based insulations.

It is another object of the present invention to provide an insulation cutoff apparatus that includes a variable depth guide for controlling the depth of the cutting action.

It is another object of the present invention to provide an insulation cutoff apparatus that provides greater speed and force to the cutting implement of the cutoff apparatus.

These and other objectives of the present invention, and their preferred embodiments, shall become clear by consideration of the specification, claims and drawings taken as a whole.

### BRIEF DESCRIPTION OF THE DRAWINGS

FIG. 1 is a partial cross-sectional side view of the cutting implement of the insulation cutoff apparatus, according to one embodiment of the present invention.

FIG. 2 is a partial cross-sectional front view of the insulation cutoff apparatus depicted in FIG. 1.

FIG. 3 is a partial cross-sectional top view of the insulation cutoff apparatus depicted in FIG. 1.

FIG. 4 is a partial cross sectional side view of an insulation feed and cutting machine for supporting the insulation cutoff apparatus, according to one embodiment of the present invention.

### DETAILED DESCRIPTION OF THE PREFERRED EMBODIMENT

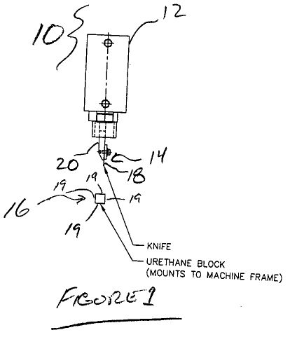

FIG. 1 is a partial cross-sectional side view of the insulation cutoff apparatus 10, according to one embodiment of the present invention. As shown in FIG. 1, the insulation cutoff apparatus 10 includes a pneumatically actuated air cylinder 12 and a cutting assembly 14. A cutting block 16 is disposed beneath the cutting assembly 12 and provides a resilient medium against which the cutting assembly 16 may selectively and repetitively abut during cutting operations, as will be described shortly hereafter. It will be readily appreciated that the air cylinder 12, the cutting assembly 14 and the cutting block 16 are intended to be mounted to a suitable machine frame which may or may not support additional apparatuses, without departing from the broader aspects of the present invention.

As depicted in FIG. 1, the present invention envisions that the cutting assembly 14 includes a knife member 18 that is rectilinearly displaceable via the selective operation of a cutting shaft 20 by the air cylinder 12. Moreover, the cutting block 16 is preferably fabricated from urethane, however other resilient materials may be utilized without departing from the broader aspects of the present invention. The knife member 18 preferably employs a thin, sharpened steel blade to effect the cutting action.

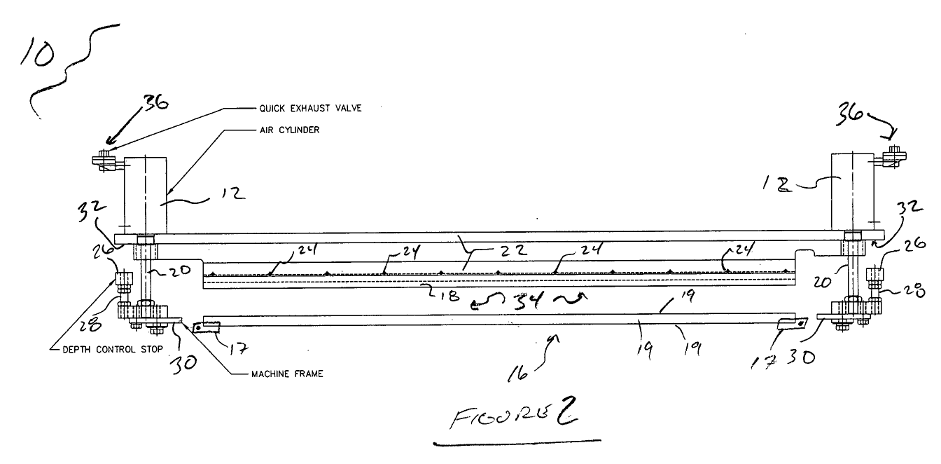

Turning now to FIG. 2, a partial cross-sectional front view of the insulation cutoff apparatus 10 is shown. As depicted in FIG. 2, the knife member 18 is mounted in a blade holder 22 which extends the length of the knife member 18 and is secured thereto via a plurality of set screws 24, rivets, bolts or the like. The blade holder 22 is itself operatively coupled to the cutting shaft 20 so as to enable rectilinear movement of the blade holder 22 and the knife member 18 during actuation of the air cylinder 12. As compared to known cutting devices, the blade holder 22 is fashioned from a heavier gauge metal, or the like, in order to absorb the additional force necessary to cut the new generation of insulating materials, such as but not limited to a cotton-based web.

A depth control stop 26 is provided to a control shaft 28 which, in turn, is fixed to a frame member 30. The frame member 30 is itself secured to the end of the cutting shaft 20, as is shown in FIG. 2. The stop 26 may be selectively positioned on the control shaft 28 so as to regulate the downward rectilinear movement of the blade holder 22. As will be appreciated, positioning the stop 26 higher on the control shaft 28 will cause the blade holder 22 to be arrested in its downward movement to a greater extent than would be the case if the stop 26 was alternatively mounted lower on the control shaft 28. The stop 26 may be positioned on the control shaft 28 via a threaded bolt and nut assembly, linch pin configuration, or the like, without departing from the broader aspects of the present invention.

It is therefore an important aspect of the present invention that the substantially planar interaction between the stop 26 and a control surface 32 of the blade holder 22 will assuredly and repeatedly prevent the knife member 18 from any excessive impact on the cutting block 16. That is, the selective placement of the stop 26 on the control shaft 28 is capable of ensuring that any insulation passing through the operative opening 34 will be completely severed, while also precisely regulating the degree to which the knife member 18 impacts the cutting block 16. In this manner, the insulation cutoff apparatus 10 of the present invention is advantageously capable of minimizing—to the extent possible—gratuitous damage to the cutting block 16 and thus extending the usable life of the cutting block 16 while reducing operating costs.

In addition to the effect of the stop 26, the present invention also provides a releasable mounting system for releasably fixing the cutting block 16 to a portion of the frame member 30. It will be readily appreciated that the releasable mounting system may comprise known torque brackets (such as, but not limited to, clamps or the like) 17, disposed on either side of the cutting block 16 for securing the cutting block 16 therebetween, or the like, provided that the releasable mounting system is capable of selectively disengaging from the cutting block 16. Once released from the securing action of the releasable mounting system, the cutting block 16 may be rotated about its longitudinal axis, turned over and repositioned so that an impact line from the knife member 18 can be distributed over a plurality of areas on the cutting block 16, thus further extending the usable life of the cutting block 16.

As shown in FIGS. 1 and 2, the cutting block 16 includes a plurality of discreet and substantially planar surfaces 19. Each of the planar surfaces 19 may, in turn, be alternatively positioned adjacent the knife member 18 so as to sequentially provide a different impact surface for the knife member 18, as previously discussed. In addition to rotating the cutting block 16 so as to present a different planar surface 19 beneath the knife member 18, the present invention also contemplates positioning differing areas of the same planar surface 19 in opposition to the knife member 18. That is, without rotating the cutting block 16 about is longitudinal axis, the cutting block 16 may be shifted slightly, in a direction substantially perpendicular to the plane of the rectilinearly movable knife member 18, thus altering the impact position of the knife member 18 upon the planar surface 19.

Moreover, as the cutting block 16 is preferably positioned such that the initial impact line of the blade member 18 is slightly off center with respect to each of the planar surfaces 19, the cutting block may alternatively be flipped such that each of the planar surfaces 19 provide at least two off-center impact lines.

It is therefore an important aspect of the present invention that the cutting block 16 may be selectively rotated, shifted or flipped to present differing impact locations for the knife member 18, thus significantly increasing the usable life-span of the cutting block 16 while reducing operational costs. While a cutting block 16 having four opposing impact surfaces 19 has been shown in FIGS. 1 and 2, the present invention is not limited in this regard as the cutting block 16 may have any number of impact surfaces 19 without departing from the broader aspects of the present invention.

As is also shown in FIG. 2, the present invention includes dual air cylinders 12 on either distal end of the blade holder 22. As again compared to known cutting devices, the dual air cylinders 12 are larger in size in order to provide the knife member 18 with the greater speed and force necessary to cut the new generation of insulating materials, such as but not limited to a cotton-based web, or the like.

In addition to their increased size, the dual air cylinders 12 have each been equipped with a quick exhaust valve 36 operatively connected to the air cylinders 12. The quick exhaust valves 36 are preferably automatically actuated during the downward cutting action of the blade member 18, although they may be alternative actuated upon the conclusion of a downward cutting action by the blade member 18. The quick exhaust valves 36 thereby enable a faster resetting of the air cylinders 12, thus leading to a greater number of possible cuts per unit time than has been known heretofore in the art. The combination of the larger air cylinders 12 and the quick exhaust valves 36 attached thereto give the insulation cutoff apparatus 10 of the present invention the ability cleanly and repeatedly cut through swaths of insulation with an efficiency heretofore unknown in the art.

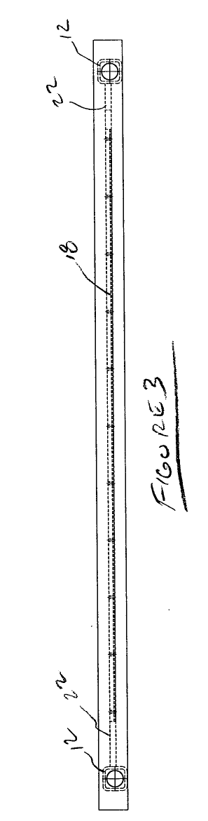

FIG. 3 is a partial cross-sectional top view of the insulation cutoff apparatus 10 illustrating the relative positions of the air cylinders 12, the blade member 18 and the blade holder 22. It will be readily appreciated that by orienting the air cylinders 12 on either distal end of the blade holder 22, the present invention ensures that the force applied by the blade member 18 is substantially equal along the entire longitudinal length of the blade member 18, thus providing an accurate and even cut to the insulation passing thereunder.

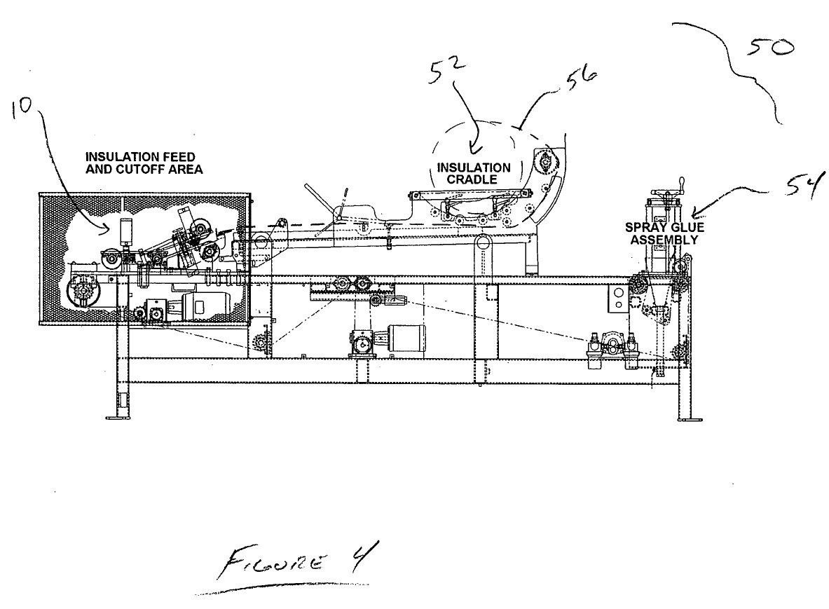

FIG. 4 illustrates partial cross sectional side view of an insulation feed and cutting machine 50, according to one embodiment of the present invention. As shown in FIG. 4, the insulation cutoff apparatus 10 is incorporated into and disposed adjacent one distal end of the insulation feed and cutting machine 50, downstream from an insulation cradle 52 and an optional spray glue assembly 54.

The insulation cradle 52 is adapted to hold rolls 56 (shown in phantom in FIG. 4) of insulation thereon for subsequent feeding to the cutoff apparatus 10. While a roll 56 of insulation has been described, it will be readily appreciated that the present invention is not limited in this regard and that insulation stored as planar sheets, or the like, are also contemplated by the present invention. Indeed, the insulation feed and cutting machine 50 depicted in FIG. 4 is but one embodiment for supporting the cutoff apparatus 10 of the present invention, the structure of which may be changed, e.g., to accommodate planar sheets of insulation for feeding to the cutoff apparatus 10, without departing from the broader aspects of the present invention.

As will be appreciated by consideration of FIGS. 1-4, the present invention provides an insulation cutoff apparatus 10 which is capable of repetitively performing a severing action on even the newer generation of insulating materials. It should be noted that although a pair of pneumatically actuated air cylinders 12 have been described in conjunction with the insulation cutoff apparatus 10, the present invention is not limited in this regard as other thrust architectures, such as but not limited to hydraulic or solenoid actuated assemblies, may be alternatively utilized to drive the knife member 18 without departing from the broader aspects of the present invention. Moreover, it will be readily appreciated that while a thin, sharpened steel blade has been described, the present invention equally contemplates the use of ceramic or composite knife members, or the like.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all equivalent embodiments.

What is claimed is:

1. An insulation cutoff apparatus, comprising:
a blade;
an actuator, said actuator being operatively connected to said blade for selectively moving said blade in a rectilinear direction;
a cutting block disposed adjacent said blade, said cutting block being selectively movable so as to position differing areas of said cutting block in opposition to said blade;
a depth control mechanism for selectively controlling a degree of movement of said blade toward said cutting block; and
wherein operation of said actuator selectively causes said blade to move in said rectilinear direction thereby impacting said cutting block to an extent in accordance with said depth control mechanism.

2. The insulation cutoff apparatus according to claim 1, wherein:
said cutting block is made from urethane.

3. The insulation cutoff apparatus according to claim 1, wherein:
said actuator comprises a pair of pneumatically operated cylinders operatively disposed on opposing distal ends of said blade.

4. The insulation cutoff apparatus according to claim 1, wherein:
said cutting block is selectively shiftable in a direction substantially perpendicular to said rectilinear direction, thus altering an impact line of said blade upon said cutting block.

5. The insulation cutoff apparatus according to claim 1, wherein:
said cutting block includes two impact surfaces, said cutting block being selectively rotatable about its longitudinal axis, thus selectively positioning one of said two impact surfaces in opposition to said blade.

6. The insulation cutoff apparatus according to claim 5, further comprising:
a releasable mounting system for releasably securing said cutting block in opposition to said blade.

7. The insulation cutoff apparatus according to claim 1, wherein:
said blade is a ceramic blade.

8. The insulation cutoff apparatus according to claim 1, wherein:
said depth control mechanism includes a threaded adjustment assembly having a planar stop positioned thereon;
said blade is fixed to a blade holder having a planar control surface defined on a distal end thereof; and
wherein said planar stop and said planar control surface operate to control said degree of movement of said blade towards said cutting block.

9. The insulation cutoff apparatus according to claim 3, further comprising:
a quick exhaust valve operatively connected to each of said pneumatically operated cylinders, said quick exhaust valves automatically actuating during said rectilinear movement of said blade member towards said cutting block.

10. A cutoff apparatus, comprising:
a blade;
an actuator, said actuator being operatively connected to said blade for selectively moving said blade in a rectilinear direction;
a cutting block disposed adjacent said blade, said cutting block being positioned off-center with respect to a plane defined by said blade's rectilinear movement;
a depth control mechanism for selectively controlling a degree of movement of said blade toward said cutting block; and
wherein operation of said actuator selectively causes said blade to move in said rectilinear direction thereby impacting said cutting block to an extent in accordance with said depth control mechanism.

11. The cutoff apparatus according to claim 10, wherein:
said cutting block is selectively movable so as to position differing areas of said cutting block in opposition to said blade.

12. The insulation cutoff apparatus according to claim 10, wherein:
said cutting block is made from urethane.

13. The insulation cutoff apparatus according to claim 10, wherein:
said actuator comprises a pair of pneumatically operated cylinders operatively disposed on opposing distal ends of said blade.

14. The insulation cutoff apparatus according to claim 10, wherein:
said cutting block is selectively shiftable in a direction substantially perpendicular to said rectilinear direction, thus altering an impact line of said blade upon said cutting block.

15. The insulation cutoff apparatus according to claim 10, wherein:
said cutting block includes two impact surfaces, said cutting block being selectively rotatable about its longitudinal axis, thus selectively positioning one of said two impact surfaces in opposition to said blade.

16. The insulation cutoff apparatus according to claim 10, further comprising:
a releasable mounting system for releasably securing said cutting block in opposition to said blade.

17. The insulation cutoff apparatus according to claim 10, wherein:
said blade is a ceramic blade.

18. The insulation cutoff apparatus according to claim 10, wherein:
said depth control mechanism includes a threaded adjustment assembly having a planar stop positioned thereon;
said blade is fixed to a blade holder having a planar control surface defined on a distal end thereof; and
wherein said planar stop and said planar control surface operate to control said degree of movement of said blade towards said cutting block.

19. The insulation cutoff apparatus according to claim 13, further comprising:
a quick exhaust valve operatively connected to each of said pneumatically operated cylinders, said quick exhaust valves automatically actuating during said rectilinear movement of said blade member.

20. A method for cutting insulation, said method comprising the steps of:
operatively connecting an actuator to a blade for selectively moving said blade in a rectilinear direction;
disposing a cutting block adjacent said blade, said cutting block being positioned off-center with respect to a plane defined by said blade's rectilinear movement;
positioning a depth control mechanism for selectively controlling a degree of movement of said blade toward said cutting block; and
wherein operation of said actuator selectively causes said blade to move in said rectilinear direction thereby impacting said cutting block to an extent in accordance with said depth control mechanism.
